(19) United States
(12) Patent Application Publication
(10) Pub. No.: US 2008/0178388 A1
(43) Pub. Date: Jul. 31, 2008

(54) ADJUSTABLE BED

(76) Inventor: FERDINAND SCHERMEL, Brampton (CA)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 12/019,518

(22) Filed: Jan. 24, 2008

Related U.S. Application Data
(60) Provisional application No. 60/886,812, filed on Jan. 26, 2007.

(51) Int. Cl. A61G 7/002

(52) U.S. Cl. 5/618; 5/617; 5/613

(57) ABSTRACT

An adjustable wallhugger bed that allows the user to lower the users thighs and calves into a generally downward angle, which allows for greater comfort, as well as improved utility of the bed.

### I. CROSS-REFERENCE TO RELATED APPLICATIONS

This application claims the priority benefit of the provisional U.S. Patent Application No. U.S. 60/886,812.

### II. BACKGROUND OF THE INVENTION

This invention relates generally to beds and more particularly to powered adjustable beds. Adjustable beds have been used for many years to permit the user to adjust the head and foot sections of the bed to different positions. While originally only manually adjustable, more recently, the head and foot sections are moved by motors operated by the user via a remote control.

Adjustable beds were originally designed principally for use in medical environments by patients who had to spend long periods of time in bed for reasons of health, injury, etc. However, more recently, adjustable beds are also being used in residential environments by users who have no health or physical impairment. An increasing number of people place televisions and other media based entertainment devices in the bedroom, and more time is spent lounging in bed.

Hence, the bed, and in particular an adjustable bed, is considered by many users an alternative piece of leisure furniture. As the market for leisure beds grows, there is continuing effort by suppliers to provide leisure beds that are more comfortable, have more options, for example, massage capabilities, have more sophisticated controls, and are more affordable.

One recent development in adjustable beds is the development of a “wallhugger” adjustable bed. The function of a wallhugger adjustable bed is to maintain the user in the same position with respect to adjacent appliances and furniture as the head portion of the bed is moved between flat and elevated positions. To achieve that purpose, as the head section pivots upward, an upper bed frame portion translates toward the head end of the bed with respect to a stationary lower bed frame section. One example of such a bed is disclosed in U.S. Pat. No. 5,577,280. There are numerous complexities in known adjustable bed designs. For example, referring to FIG. 11 of the '280 patent, the motors 92, 96 have respective drive shafts extending under the head and thigh sections, respectively. Thus, when the head and thigh sections are elevated, the motor shafts and elevation linkage are visible. In addition referring to FIG. 5 of the '280 patent, torque tube 182 rotates about a pivot point 180. That swinging or rotating of torque tube 182 about a point noncoincident with its centerline requires a relatively complex and expensive structure. Further referring to FIGS. 3 and 1 of the '280 patent, links 264 are pivotally connected to brackets 271 which are rigidly connected to side rails 154. Such a construction creates undesirable or torsional forces at the extreme ends of the side rails 154. The '280 patent also discloses in FIGS. 17-19, a mechanism by which the upper frame is translated on the lower frame. The mechanism includes upper and lower wheels that capture a horizontal track mounted on the lower frame.

In U.S. Pat. No. 6,101,647, an adjustable bed is disclosed having an upper frame mounted to translate with respect to a lower frame. A center support is connected to the upper frame and has a head support pivotally connected to one end thereof. A thigh support is pivotally connected to the other end of the center support and a foot support is connected to the other end of the thigh support. First and second motors are operatively connected between the upper frame and the head and thigh supports to pivot the head and thigh supports with respect to the center support. The upper frame is linked to the lower frame so that as the head support is pivoted up, the upper frame is translated toward the head end of the bed, thereby maintaining the head support at a relatively fixed position with respect to appliances and furniture adjacent the head end of the bed.

Thus, there is a need to provide an adjustable wallhugger bed that allows the user to lower the users thighs and calves into a generally downward angle. This position allows for greater comfort, as well as improved utility of the bed.

### III. SUMMARY OF THE INVENTION

The present invention provides an adjustable bed that allows the user to adjust the angles of multiple sections of the bed to suite the preferences of the user. In particular, the present invention allows the user to drop the level of the thigh and/or calf section(s) of the bed. This improvement is accomplished in several embodiments. Generally, the frame includes two horizontal parallel tracks along the length of the frame that allow a carriage apparatus to move along. The carriage apparatus is propelled by a powered actuator attached to the frame and the carriage apparatus to tilt the back section. Additional actuators may be attached to other sections of the bed surfaces, including the head rest portion of the back section, the buttocks section, the thigh section, and the calf section. In a preferred embodiment, the use of a swing arm allows the back section to be raised and lowered without an actuator attached to that section, but by using the movement of the carriage apparatus, and a swing arm attached to the back section. This embodiment allows the back section to be raised by causing the carriage apparatus to move towards the head side of the bed, and lowered by moving the carriage apparatus towards the foot side of the bed.

Another novel and important feature of the invention is the location of the tracks, relative to the location of the feet. The locations are important since they allow the thigh and calf sections to be lowered at a downward angle, and also to a position below the level of the track. This feature greatly enhances the comfort and utility of the bed, and can be accomplished in multiple ways. First, the shape of the bed's legs can influence the ability of the thigh and calf sections to angle downwards and also to allow the calf section to be lowered below the level of the tracks. For instance, when the legs are shaped in as arches, this allows for this feature. Also, when the legs on the foot side of the bed are cantilevered, this also allows the foot section to drop below the level of the tracks. Of course, for this feature to be operable, the tracks must terminate substantially before reaching the ends of the leas (where the legs come into contact with the floor). Another feature that allows for this function has the actuator for the calf and thigh sections secured to an independent swinging frame holding the calf and thigh section at one end and to the base of the carriage at the other end. The angle of the this actuator supports the calf and thigh section in a cantilever position overhanging the carriage extending past and over the track ends, which are part of the frame.

Another feature that allows for this function has the actuator for the calf section attached to the underside of the thigh section and angled upwards towards the calf section. This cantilevered angle of the this actuator supports the foot section, even when it is not directly over the carriage apparatus (extended past the frame).

The bed is will have a plurality of separate, independently adjustable sections, including back, buttocks, thigh, and calf sections. These sections will be supported by supporting elements that are attached to each other via hinges. These hinges are preferably raised above the plane of the supporting elements, as this location has shown to enhance the utility of the bed by reducing wrinkling of the bedding material on the bed. The hinges allow the different sections to change and/or maintain various angles between the sections.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### IV. BRIEF DESCRIPTION OF THE DRAWINGS

FIG. 1 is a perspective view of the invention utilizing arched legs, wherein the back section is elevated and the buttocks, thigh and calf sections are in the horizontal position.

FIG. 2 is a perspective view of the invention utilizing arched legs, wherein the back section is elevated and the buttocks section is horizontal, the thigh section is elevated and the calf section is horizontal.

FIG. 3 is a side rear perspective view of the invention utilizing arched legs, wherein the back section is elevated, the buttocks section is elevated, and the thigh and calf sections are in the decline position.

FIG. 4 is a perspective view of the invention utilizing arched legs, wherein the back, buttocks, thigh and calf sections are in the horizontal position.

FIG. 5 is a perspective view of the invention utilizing arched legs, wherein the back, buttocks, thigh and calf sections are in the horizontal position.

FIG. 6 is a perspective view of the invention utilizing arched legs, wherein the back section is elevated, and the buttocks, thigh and calf sections are in the horizontal position.

FIG. 7 is a perspective view of the invention utilizing arched legs, wherein the back section is elevated, and the buttocks, thigh and calf sections are in the horizontal position.

FIG. 8 is a perspective view of the invention utilizing arched legs, wherein the back section is elevated, and the buttocks, thigh and calf sections are in the horizontal position.

FIG. 9 a side rear perspective view of the invention utilizing arched legs, wherein the back section is elevated, the buttocks section is elevated, and the thigh and calf sections are in the decline position.

FIG. 10 illustrates a side view of a section view showing the mattress brace 17 in it's unfolded position.

FIG. 11 illustrates a side view of the mattress brace in the folded down position ready for transport.

FIG. 12 illustrates a perspective view of the mattress braces in the folded down position ready for transport

FIG. 13 illustrates a perspective view of the bed with the leg section 2 and butt section 3 fully lowered.

FIG. 14 illustrates a side view of the bed with the leg section 2 fully lowered and butt section 3 elevated.

FIG. 15 illustrates a side view of an embodiment of the invention where the lower limit or path where the computer will coordinate the butt section and coplanar leg section motors to move the foot edge.

FIG. 16 illustrates an embodiment of an alternative embodiment to the arched leg 1 and cross member secured to leg 12.

FIG. 17 illustrates an embodiment of an alternative embodiment to the arched leg 1 and cross member secured to leg 12.

FIG. 18 illustrates an embodiment of an alternative embodiment to the arched leg 1 and cross member secured to leg 12.

FIG. 19 illustrates an embodiment of an alternative embodiment to the arched leg 1 and cross member secured to leg 12.

FIG. 20 illustrates an embodiment of an alternative embodiment to the arched leg 1 and cross member secured to leg 12.

FIG. 21A—shows the mechanical layout of the bed. The frame of the back section 4 is shown elevated and the frame of the buttocks section 3 is shown horizontal. In this model the thigh section 52 is coplanar with calf section 53 and is shown in a dropped position.

FIG. 21B—is an enlargement of 21A and shows a knee elevation actuator 43 dropped along with the thigh/calve section which are all connected to the pivot swing arm 47, which is raised and lowered by the thigh/calves section actuator 41 below the horizontal position.

FIG. 22A/B show the buttocks section 3 raised in conjunction with the thigh/calf actuator 41 which supports the foot end of the thigh/calf section in a horizontal position. Head adjustable height legs 54 and foot adjustable height legs 55 allow bed to be adjusted vertically.

FIG. 23—The back section lift arms 50 and hinge axis 31 shown here are the preferred embodiment since have their axis above the metal frame. The bed is shown with the knees elevated.

FIG. 24—shows the bed with the buttocks section 3 fully tilted, coplanar thigh/calves section horizontal and back section 4 down and horizontal.

FIG. 25 illustrates an embodiment of the perimeter hinge point 23 and it's mating perimeter hinge point lowered section 24 and flex strip 22.

FIG. 26 illustrates an embodiment of the perimeter joint of FIG. 16 in it's lowered position.

FIG. 27 illustrates an embodiment of the perimeter joint of FIG. 16 in it's raised position.

FIG. 28 illustrates an embodiment wherein the hinge points are thicker (axially) to the same width as the extrusion and notches out the deck.

FIG. 29 illustrates an embodiment of the perimeter hinge point.

FIG. 30A illustrates a deck fabric 21 over deck foam 20 on plywood deck 19 on angle frame.

FIG. 30B shows FIG. 30A in an elevated position,

FIG. 31 illustrates an embodiment wherein the foam mattress angle cuts 29 and straight cut 30 to allow the relatively rigid polyurethane foam 28 to flex and to conform with the large angle movements of the butt and knee sections.

FIG. 32 illustrates an embodiment wherein the foam mattress of FIG. 22 in the horizontal position.

FIG. 33 illustrates an embodiment wherein the foam mattress of FIG. 22 in the up position.

### V. REFERENCE NUMERALS FOR DRAWINGS

1. arched leg
2. leg section, which is also referred to herein as the thigh/calf section-which comprises either a single section or a coplanar thigh/calf section or independent thigh and calf sections. The thigh/calf sections may also have separate actuators that can position these sections in various raised knee positions.
3. buttocks section
4. back section
5. base enclosure
6. bevel box spring fabric
7. rear cover
8. bevel box spring structure
9. U.S. style box spring structure
10. safety guard
11. lower leg cover
12. cross member secured to track
13. wall
14. rear cover relief
15. elastic band
16. Euro perimeter extrusion
17. mattress brace
18. deck insert
19. deck plywood
20. deck foam
21. deck cover
22. flex strip
23. perimeter hinge point
24. perimeter hinge point lowered section
25. perimeter hinge point raise only
26, angle iron frame
27. memory foam
28. polyurethane foam
29. angle cut
30. straight cut
31. hinge axis
32. level arm
33. level switch
34. controller
35. cross member secured to legs
36. remote controls wired and wireless
37. knee lift arm
38. back section stop
39. back section limit switch
40. buttocks section actuator
41. thigh/calf section actuator
42. back section actuator (moves carriage apparatus)
43. knee elevation actuator (moves thigh and calf sections to non-coplanar positions to each other)
44. track
45. carriage apparatus
46. battery
47. pivot swing arm
48. lower buttocks lift arm
49. upper buttocks lift arm
50. back section lift arm
51. knee elevation arms
52. calf section
53. thigh section
54. head adjustable height leg
55. foot adjustable height leg
56. track wheel
57. track wheel stem
58. carriage side tube

### VI. DETAILED DESCRIPTION OF THE DRAWINGS

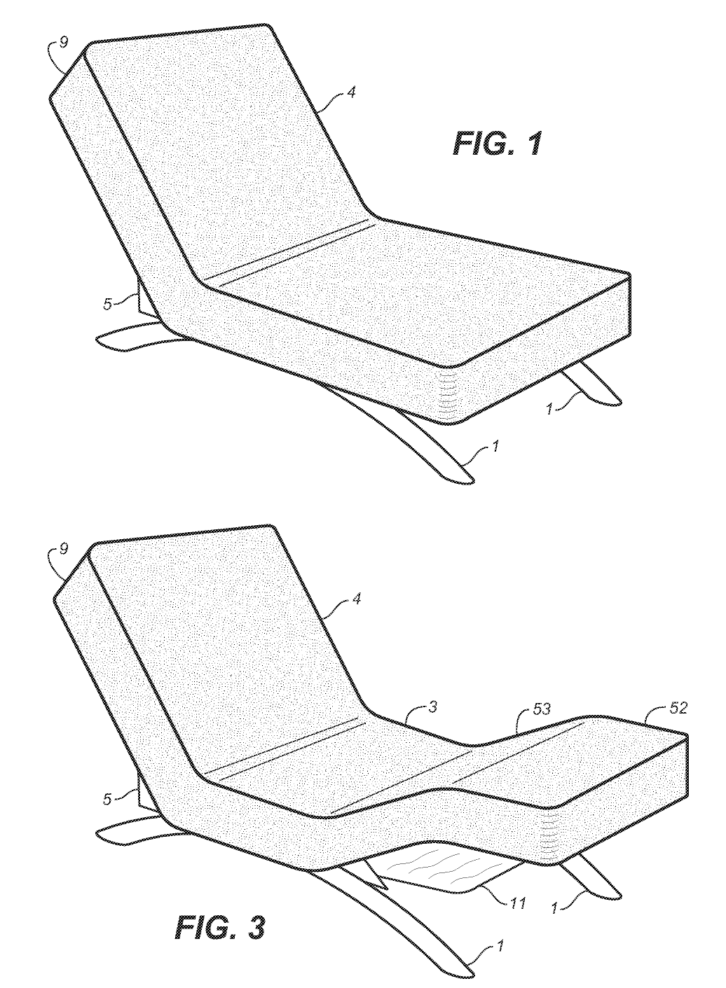

FIG. 1 shows arched legs 1 preferably made of chromed steel round tube. These legs can also be made of rectangular, square tubing or plate of various metals, as well as plastic or wood. Also shown is a U.S. style box spring structure 9 positioned on the apparatus. The back section 4 is elevated, and a section of the base enclosure 5 is also shown.

FIG. 2 shows the U.S. style box spring 9 with the back section 4 and buttocks section 3 elevated and the leg section 2 fully down. The bevel box spring fabric 6 collapses when the bevel box spring structure 8 is lifted. An alternative embodiment to is to bevel the foot end of the typical polyurethane foam perimeter covered with cloth structure, at approximately a 45 degree angle in order to provide ground clearance. The rear cover 7 is secured to the rear of the back section 4 and above the base section 5 and is made of stretchable material. The arched leg 1 allows the leg section 2 to drop close to the ground when the back section 4 is elevated.

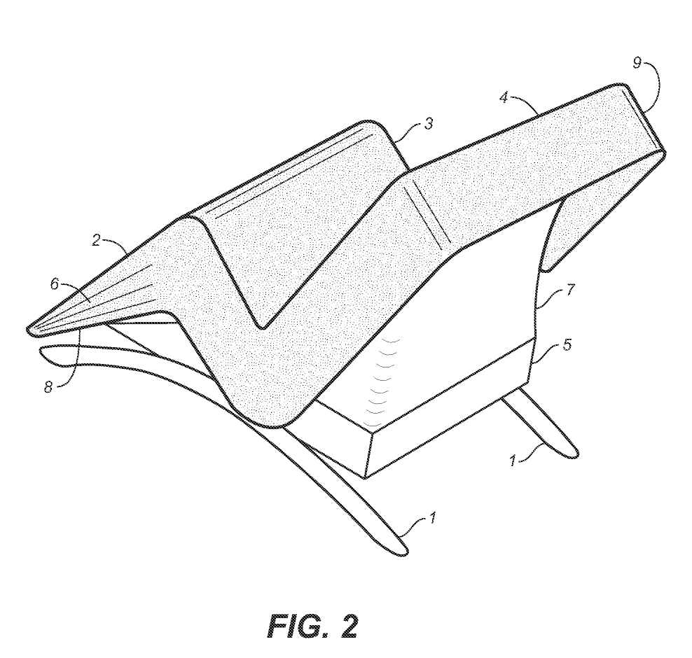

FIG. 3 shows the thigh section 53 and calf section 52 in the elevated position. The lower leg section cover 11 is made of stretchable material and is secured to the bottom of the calf section 52 to enclose the motor and frame. Both rear cover 7 and lower leg section cover 11 add safety protection as well as improve appearance.

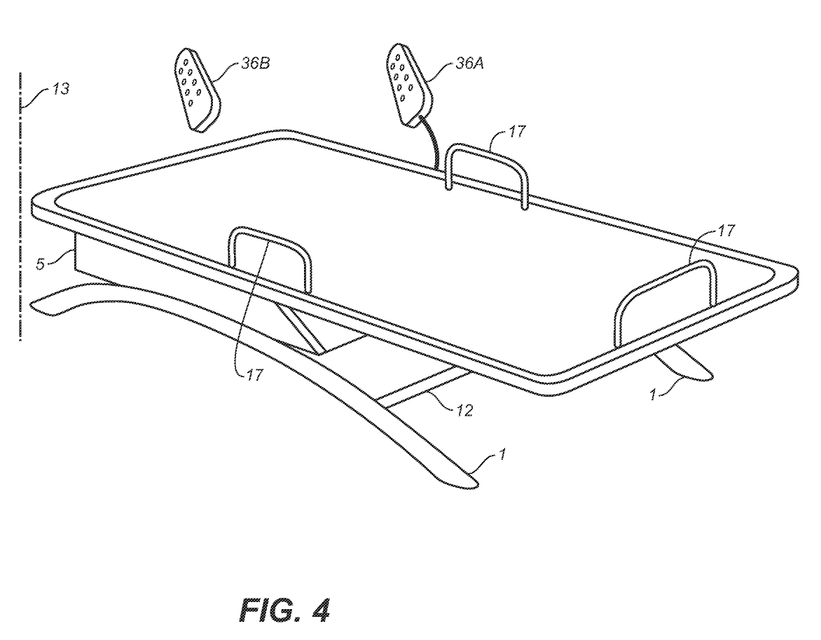

FIG. 4 shows the European (Euro) style bed with arched legs 1 secured by welding or bolting to cross member 12. Remote controls 36 are shown where each bed would have one wired 36A and one wireless 36B remote control. In the event the wireless remote 36B control being lost or batteries failing, or either remote damaged, the wired remote is readily available in a storage pouch, easily located, even in a dark room, so that a spouse is not disturbed from sleep. The mattress brace 17 allows the mattress to be easily secured into the apparatus. The back section 4 should remain at approximately the same distance from the wall 13 during operation.

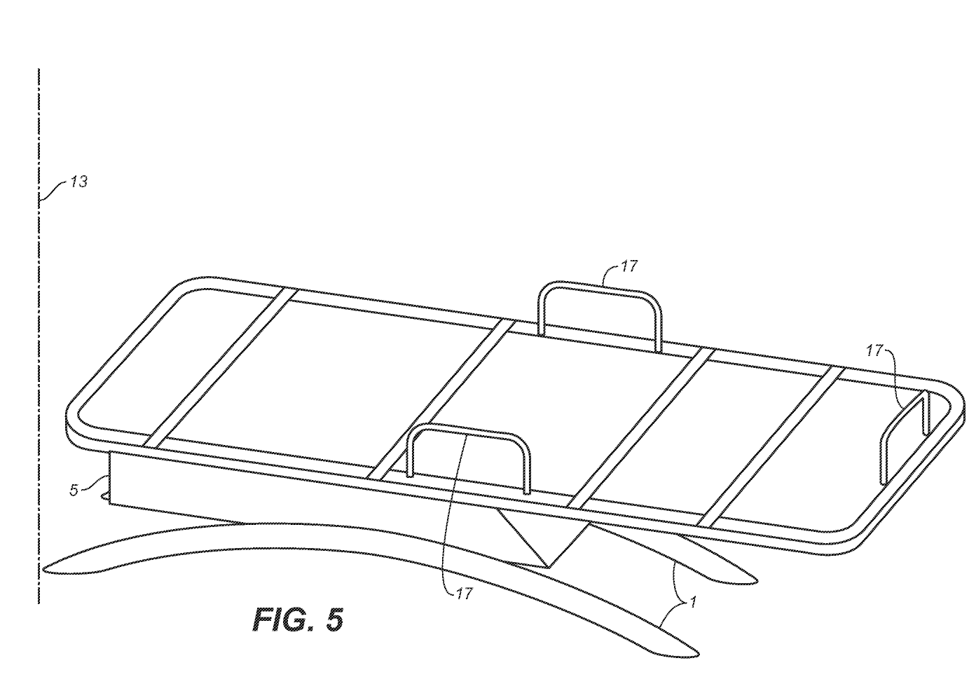

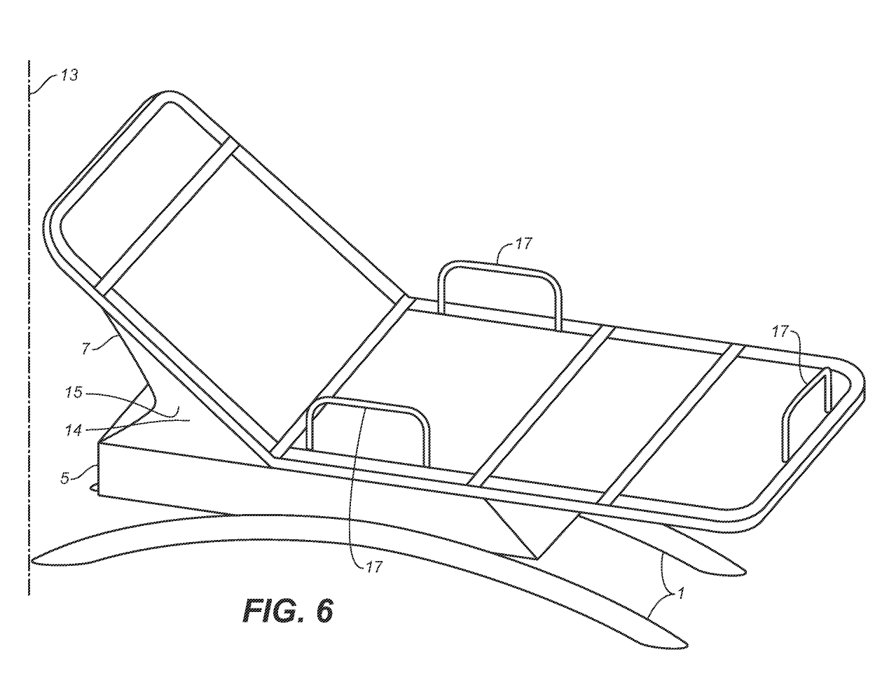

FIG. 5 shows the tip of the arched leg 1 relative to the headward edge of the bed. This ensures that the headward edge of the bed does not accidentally scrape the wall 13 as it is stationary or moving. This is also relevant with alternative embodiments of the legs. FIGS. 5-7 shows this feature that prevents bed and wall damage. The mattress brace 17, again, allows the mattress to be easily secured into the apparatus.

FIG. 6 shows the bed of FIG. 5 but with the back section partially elevated. The rear cover 7 moves with the back section simultaneously footward and downward. It also acts as a safety guard. The rear cover relief 14 is a portion of the lower vertical edge of the cover which is not attached to the back section 4 in order to allow footward travel and still reasonably conceal the rear section of the bed. The length of cover relief 14 is sufficient to allow the back section 4 to reach the horizontal position. An elastic band 15 pulls the mid section of the cover 7 footward as the back section 4 lowers as well as moves footward causing it to fold in towards the back section 4 as shown here. The rear cover 7 material is preferably stretchy or expandable to keep it tight. The elastic prevents the cover from touching motors or becoming entangled in the track 44 or linkage. As an alternate embodiment, the base enclosure 5 can be eliminated and the lower rear cover relief 14 can be secured to the track 44 (or frame) instead of base enclosure 5.

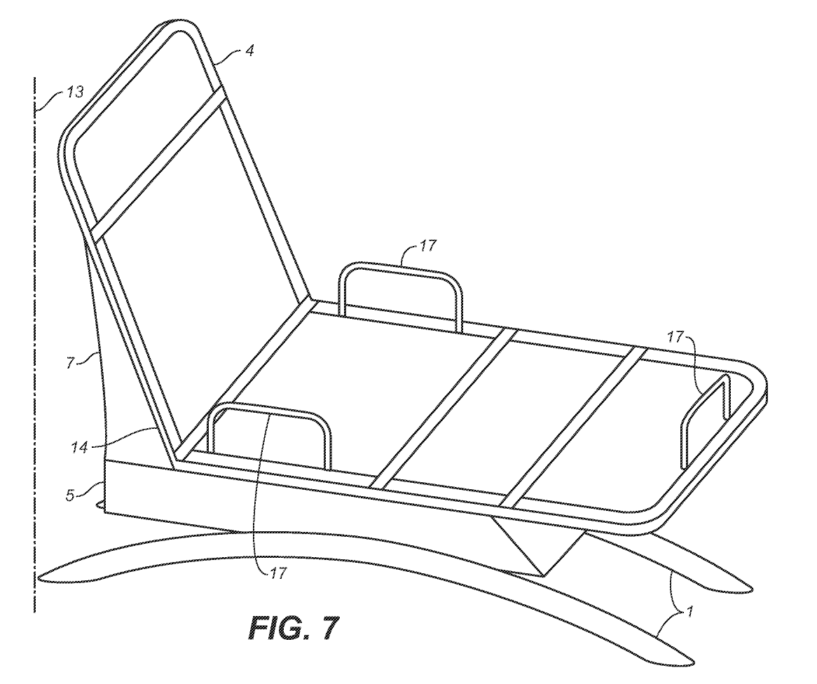

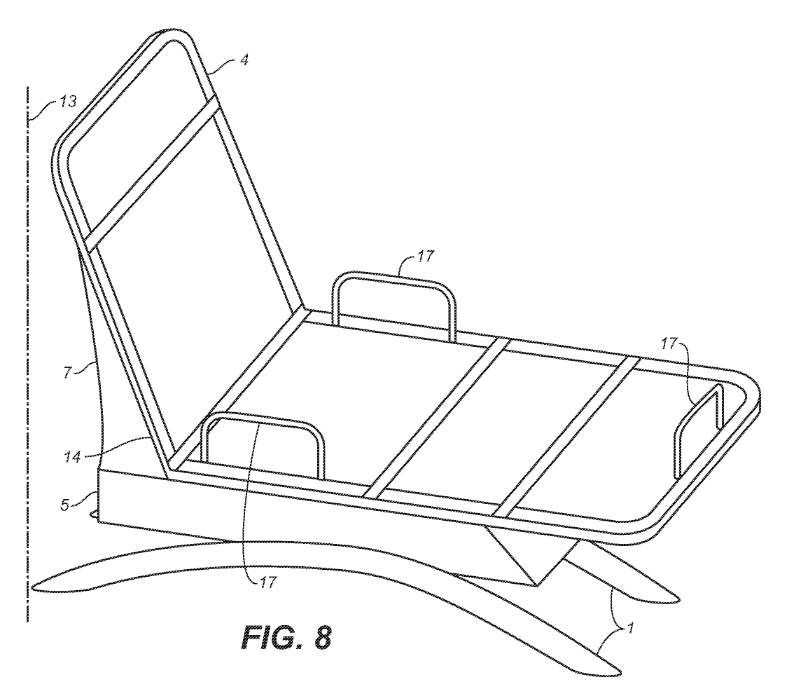

FIG. 7 shows the back section 4 fully elevated and the rear cover 7 elongated and the back section 4 touching the rear cover relief 14. This embodiment utilizes the arched legs 1, as well as the mattress braces 17. The base enclosure 5 sits atop the arched legs 1.

FIG. 8 shows the Euro style bed with shortened legs. FIG. 8 shows the back section 4 fully elevated and the rear cover 7 elongated and the back section 4 touching the rear cover relief 14. This embodiment utilizes the arched legs 1, as well as the mattress braces 17. The base enclosure 5 sits atop the arched legs 1.

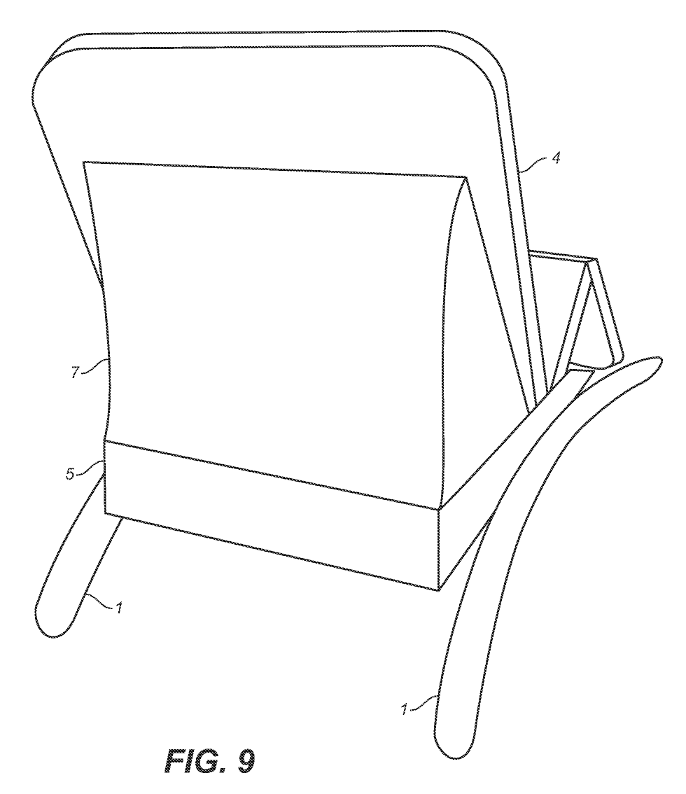

FIG. 9 is an angled rear view of the invention, showing the arched legs 1, the base enclosure 5 and the rear cover. The back section 4 is elevated above the horizontal.

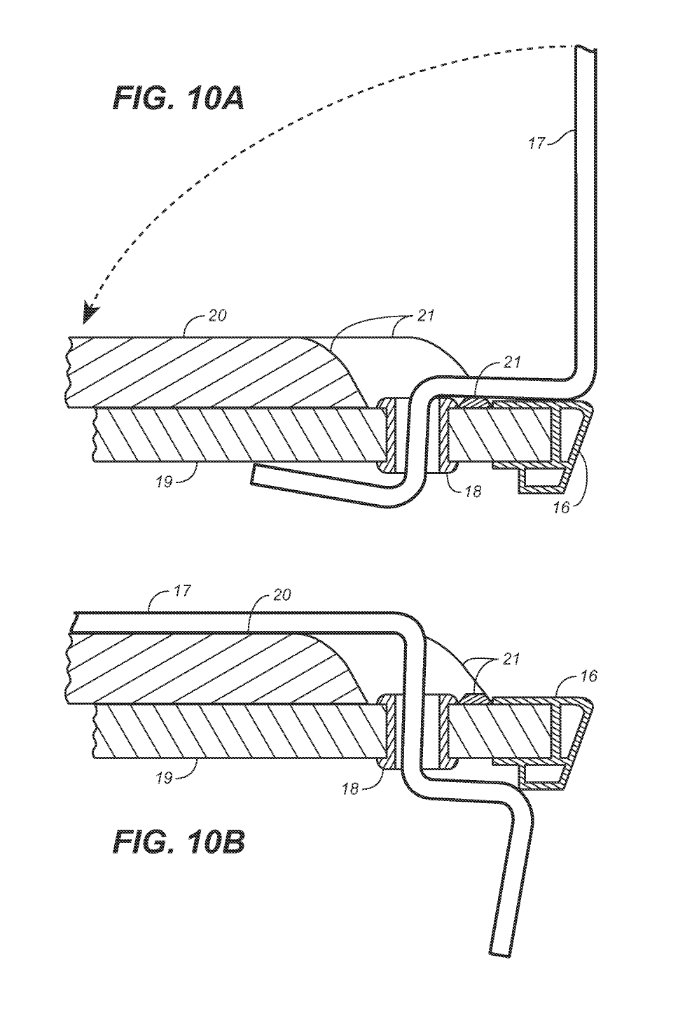

FIG. 10A is a section view showing the mattress brace 17 in it's unfolded position. Mattress braces eliminate screws and washers and customer assembly labor. The deck fabric 21 is glued, or otherwise affixed, to the deck insert to prevent runs in the fabric, but a hole in the fabric may also be made by melting using a hot iron to prevent runs. The mattress braces may be removed entirely by pulling upward as the brace 17 is rotated in the direction of the broken line and it's two ends pulled out through deck inserts 18. In the U.S. version there is no Euro perimeter extrusion 16 so the mattress brace 17 would rest on deck cover 21. The mattress brace 17 is locked in a vertical position by the end portion of the ‘s’ bend against the deck plywood 19 and by the center portion of the ‘s’ within the deck insert 18 laterally, as well as the outward force of the mattress, to the brace to maintain this locked position as shown. The deck foam 20 is shown atop the deck plywood 19. The term “deck plywood” is used since this will probably be the most cost effective material to use, however the deck can be made out of other suitable materials as well.

FIG. 10B is a section view showing the mattress brace 17 in it's folded position. Mattress braces eliminate screws and washers and customer assembly labor. The deck fabric 21 is glued, or otherwise affixed, to the deck insert to prevent runs in the fabric, but a hole in the fabric may also be made by melting using a hot iron to prevent runs. The mattress braces may be removed entirely or folded inward and downward pivotally about and through the deck insert 18 as mattress brace 17 is rotated in an upward arch while pushing down on the brace. The opposite movement results in the locking vertical and pivotally by the ‘s’ bend in the lower portion of the mattress brace 17 and the outward force of the mattress to maintain this locked position as shown in the unfolded position.

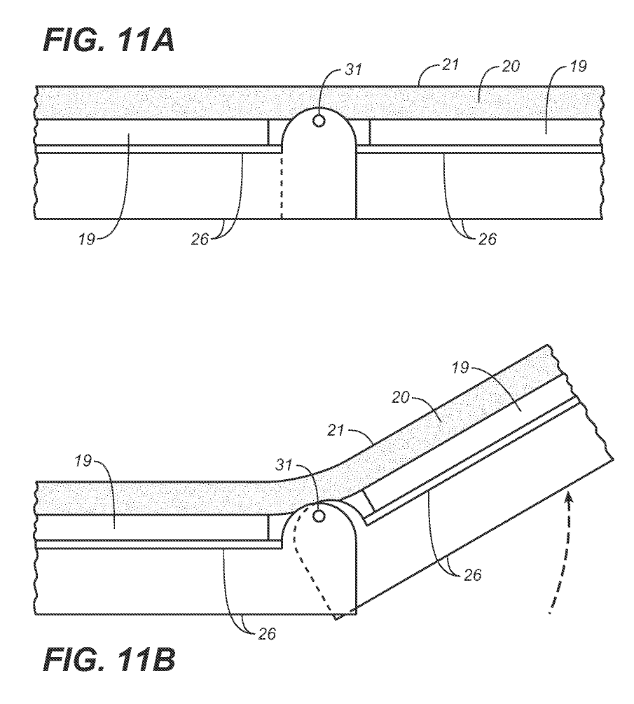

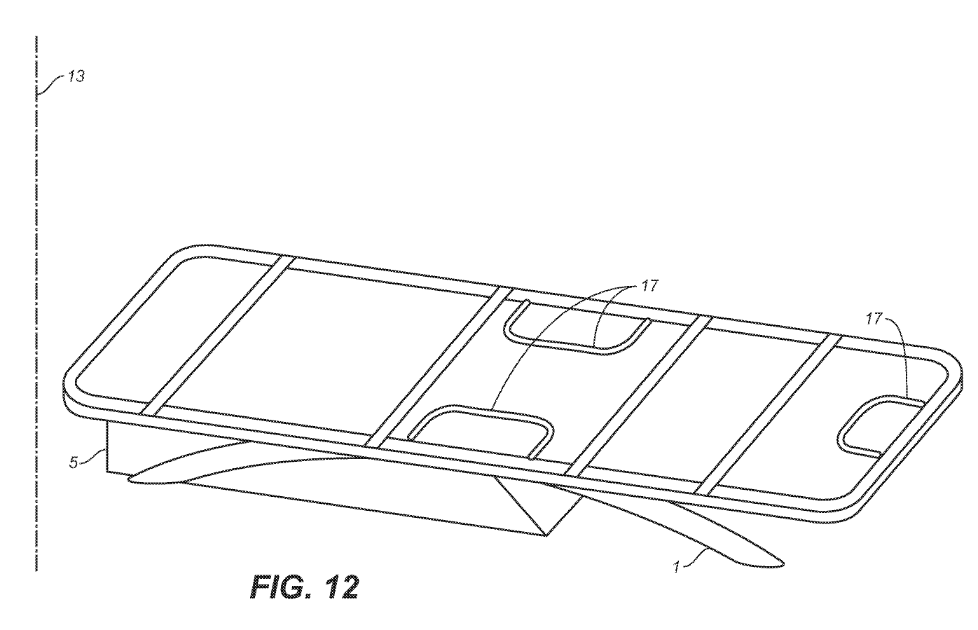

FIG. 11A shows deck fabric 21 over the deck foam 20 on a plywood deck 19 on angle iron frame 26 in a flat position. The deck section's hinge axis 31 is elevated above the frame structure, close to the top face of plywood deck 19. This reduces the gap between the plywood deck 19 sections required for clearance. This embodiment is preferable due to the greater movement of the sections as compared to common adjustable beds. This also reduces stretch and creasing of the deck cover 21 material since there is less radial movement closer to the axis.

Another purpose of the elevated axis 31 is to allow the axis to be in line with the axis of the perimeter hinge points 23 to prevent their separation or longitudinal movement. The angle iron frame 26 shown has the axis flap formed from the angle by cut and bend. The lower figure shows the upper figure but in an elevated position.

FIG. 11B shows the hinge axis 31 with the bed sections angled upwardly. If the hinge axis was located in a horizontally central height in the angle iron frame 26, it would result in deck cover 21 and deck foam 20 wrinkling as they crush together, as well as the edges of the deck plywood 19 coming close together, especially for large angles of swing. This adds risk of finger crushing as well as wear and tear instead of wrinkling, thus this bed would require much larger gaps between edges as compared to conventional small angle of movement beds, which generally have their axis located more centrally. Hence the elevated hinge axis 31 close to the surface eliminates the problem without large gaps between edges of deck plywood 19 as well as wrinkling.

FIG. 12 shows the mattress braces 17 in the folded down position ready for packaging and/or transport. The arched legs 1 are also shown in their packaging for transport position. The legs 1 unbolt from the frame and fit up under the sides of the frame so that shipping cost is reduced. The legs 1 and cross member 12 welded or bolted assembly can also fit up under the deck and frame. The legs 1 are also designed to a height that allows them to fit up under the deck for transport without adding shipping volume, whether welded with cross member secured to leg 12 or detachable or undetachable cross member secured to track 46 in place.

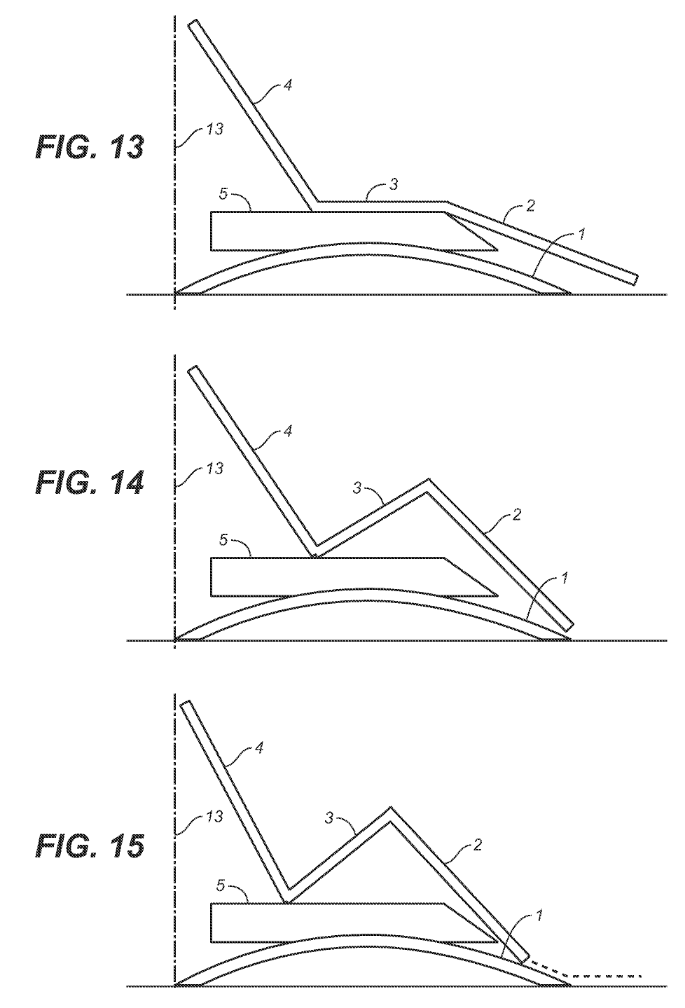

FIG. 13 is a side view showing the back section 4 elevated, with the buttocks section 3 in the horizontal position, and the leg (or “thigh/calf”) section 2 fully lowered. Again the base enclosure 5 sits atop the arched legs 1.

FIG. 14 schematically shows the bed with the leg section 2 fully lowered and butt section 3 elevated. The microprocessor and the computer program software are used to control foot edge movement. This function, which allows the double bar linkage (which produces parallel movement of the foot edge, parallel and near to the floor) while the butt section 3 is tilted up or down. This is done in order to reduce flexing of the leg section 2, while in the horizontal position, by eliminating the highly leveraged proportions needed with the double bar linkage. By allowing the clevis or the thigh/calf section actuator 41 to be hinged further towards the foot end, the high leverage is reduced. This however results in the foot edge of the leg section 2 hitting the floor and/or legs, unless the program manipulates the thigh/calf actuator 41 while the buttocks section actuator 40 motor is being operated. The motors may operate simultaneously, or stop and start of the motors to reduce the power requirement on the power supply of 2 motors instead of one. In FIG. 14, as the buttocks section is lowered, the computer would stop the buttocks section actuator 40 motor when the encoder registers a position that the foot edge of the leg section 2 is at it's lower limit in conjunction to the thigh/calf section actuator 41 position. The thigh/calf actuator 41 would automatically move the thigh/calf section 2 up if simultaneous operation is used, or the buttocks section actuator 40 would stop and the thigh/calf section 2 would raise. Stopping and switching back to the buttocks section motor to further lower the buttocks section might occur in approximately 3 inch increments of movement above the lower limit, before the desired position is reached. The same could apply in the opposite direction of movement. The computer control is made possible by the linear actuators having built in encoders used primarily for memory function. The computer automatically moves the appropriate actuator without the operator having to push the control buttons to the different actuator, but can simply hold the button down, for downward movement of the buttocks section 3, and the thigh/calf section 2 will automatically be raised before the foot edge of the bed can touch the floor. Similarly holding the thigh/calf section button down for downward movement will automatically cause the buttocks section 3 to raise before the foot edge of the bed can touch the floor.

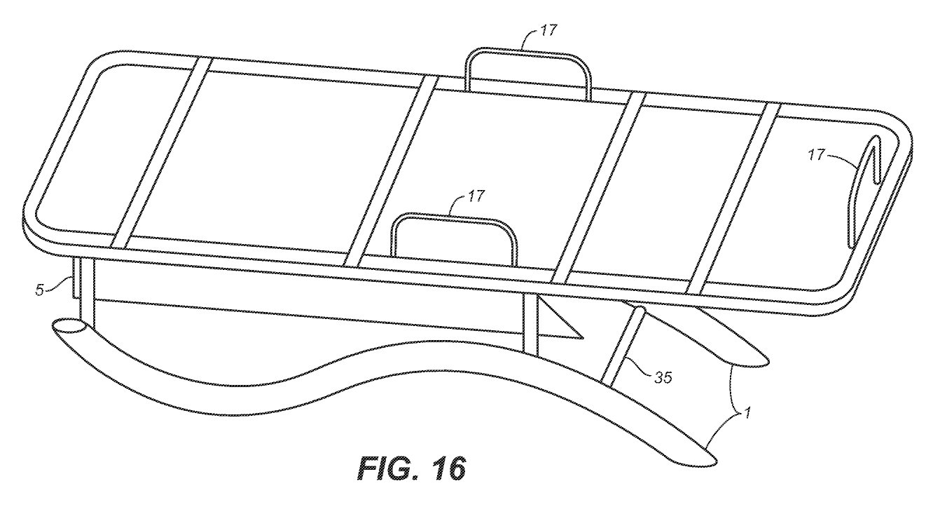

FIG. 15 shows the lower limit or path where the computer will coordinate the buttock section actuator 40 and thigh/calf section actuator 41 motors to move the foot edge, indicated by the dashed line, to prevent contact with the leg or floor. A controller can be used to simulate the original movement.

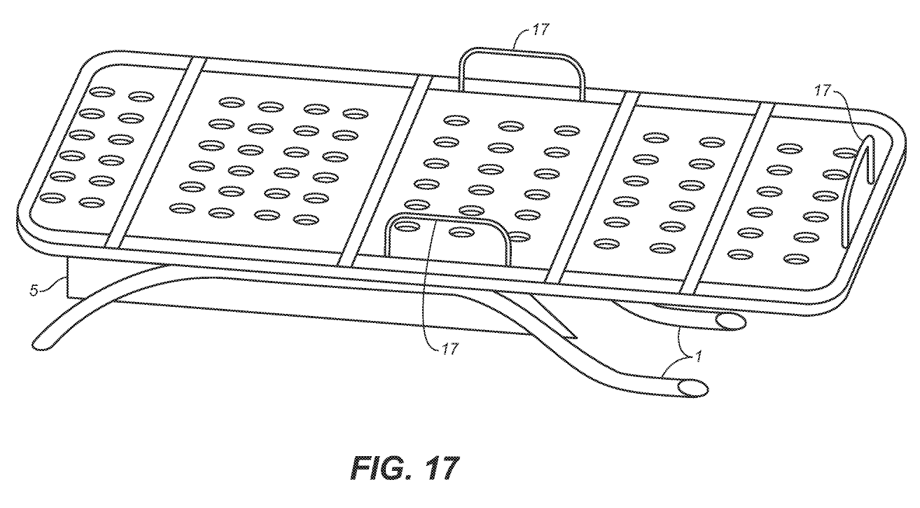

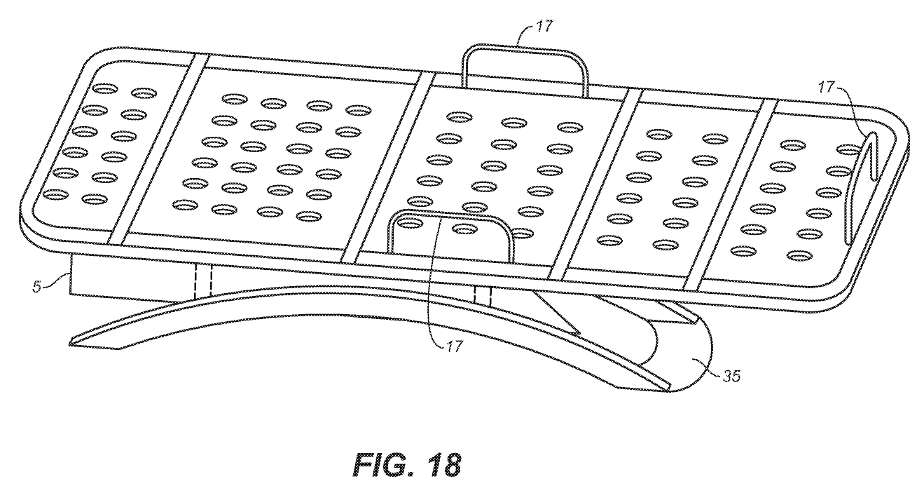

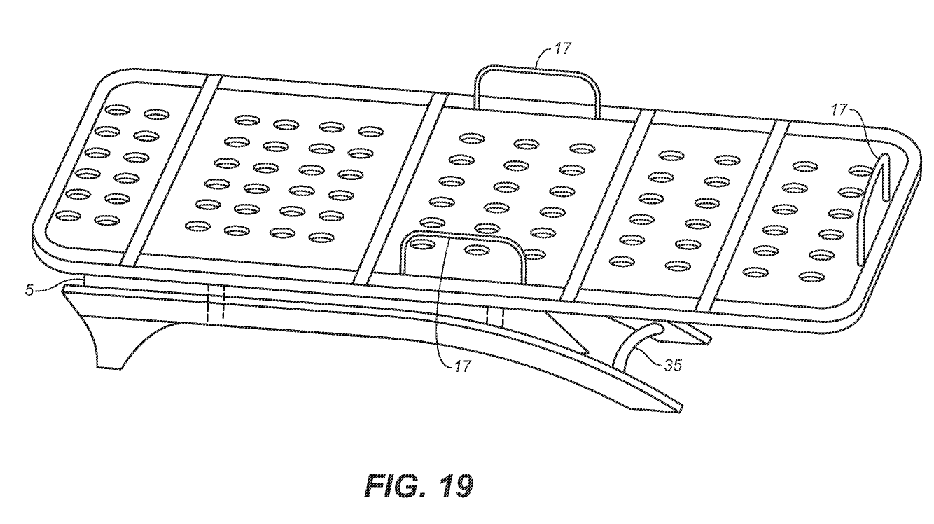

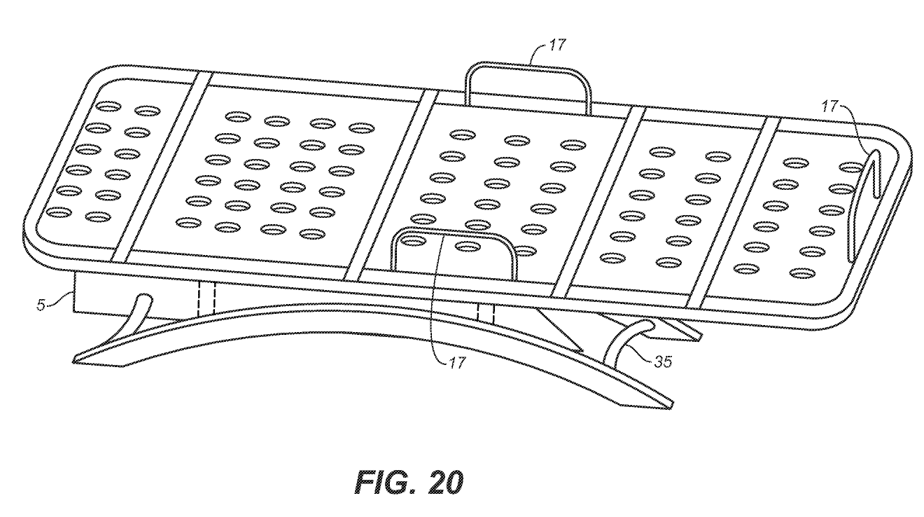

FIG. 16-FIG. 20 show alternative embodiments to the arched leg 1 and cross member 12. These embodiments can be bolted or welded legs to cross member assemblies, and have varying combinations of legs with cross members. Holes can be cut in the deck plywood 19 to allow for air ventilation through the deck foam 20 to the mattress and reduce weight.

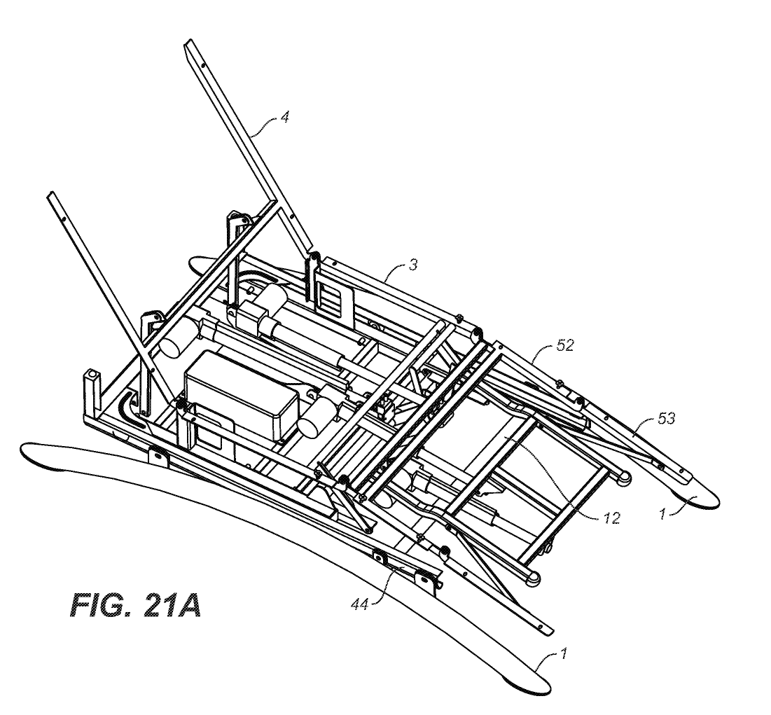

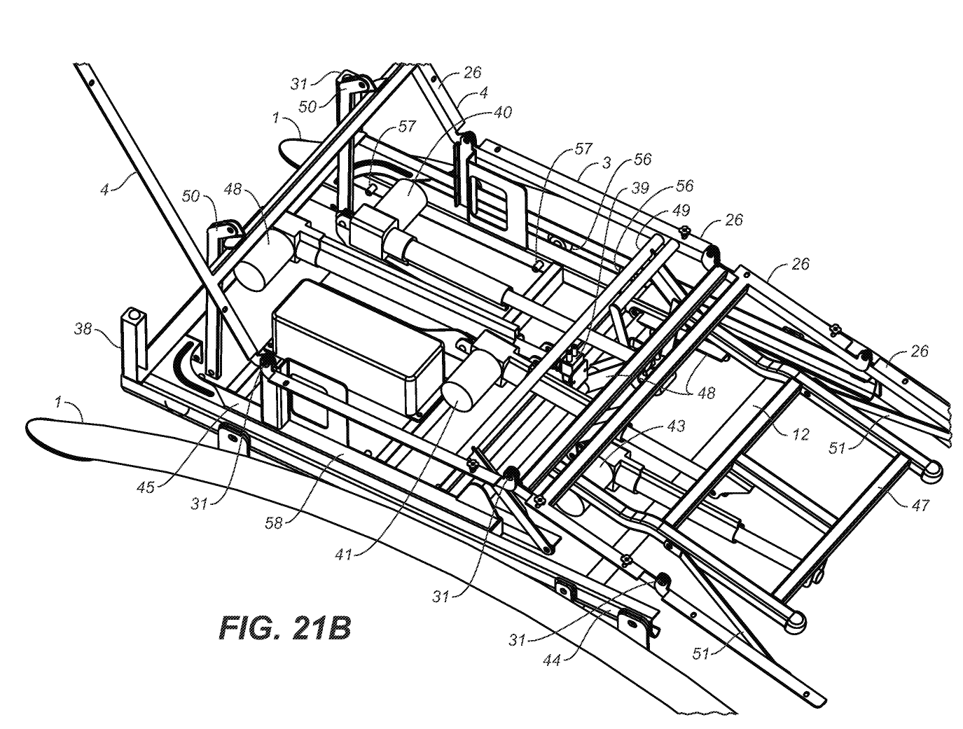

FIG. 21A—shows the mechanical layout of the bed. The arched legs 1 are bolted to the track 44 along with the cross member secured to track 12 at the foot end of the track. The frame of the back section 4 is shown elevated and the frame of the buttocks section 3 is shown horizontal. In this model the thigh section 52 is coplanar with calf section 53 and is shown in a dropped position.

FIG. 21B—is an enlargement of 21A and shows a knee elevation actuator 43 dropped along with the thigh/calve section which are all connected to the pivot swing arm 47, which is raised and lowered by the thigh/calves section actuator 41 below the horizontal position. A level arm 32 secured to the buttocks section will ensure the thigh/calve section will stop in the horizontal position when it opens the level switch 33 which is secured to the pivot swing arm 47. Even after wear, minor damage or heavy weight on foot end, the level switch and arm will allow the thigh/calve actuator 41, which has extra extension capability, to bring the coplanar thigh/calve section level relative to the buttocks section 3 when it is horizontal. A 10 degree slope is also obtained by the excess extendibility of the thigh/calve actuator 41 for sleeping with the coplanar thigh/calve sections slightly elevated. The deck plywood 19 pieces (not shown) are secured to the angle iron frame 26 to make each of the sections. The hinge axis 31 protrude above the deck plywood 19 and will be comprised of a bolt or axis pin, bushings, and washers. When the carriage 45 rolls headward in track 44 as it is moved by back section actuator 42, this causes back section lift arms 50 to raise back section 4 pivotably about the buttocks section 3. The back section lift arms 50 and hinge axis 31 show here are an alternate embodiment since they do not have their axis above the metal frame but rather below the deck plywood 19. When rolled footward the back section limit switch 39 will stop the back section actuator 42 when either the back sections comes to rest on the back section stop 38 or if an obstruction blocks further downward travel, both instances causing the end of the actuator to travel along a double slotted clevis bracket along which the clevis pin travels horizontally, compressing a spring until the switch is opened. This acts as a safety switch as well as a limit switch rather than the prior art of a detaching lift arms from back section surface and subsequent free fall after the back section becomes unobstructed.

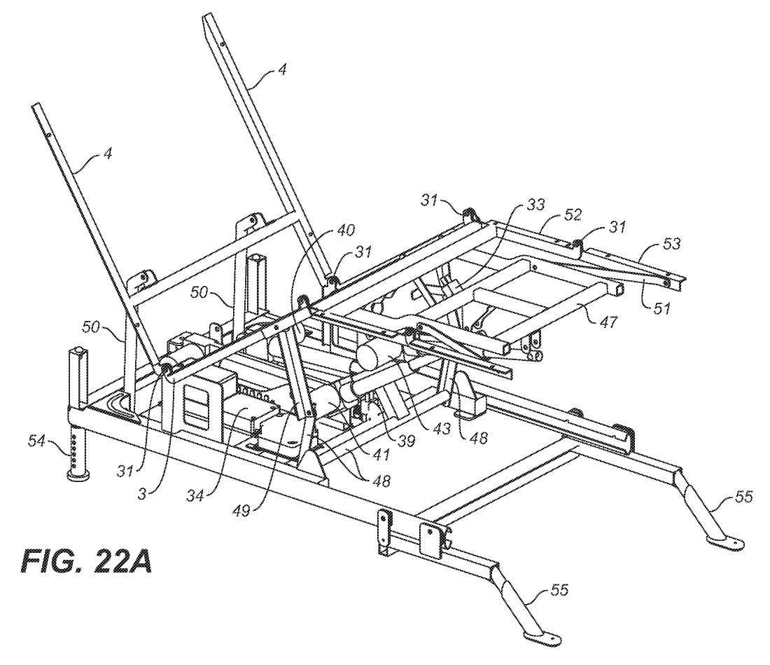

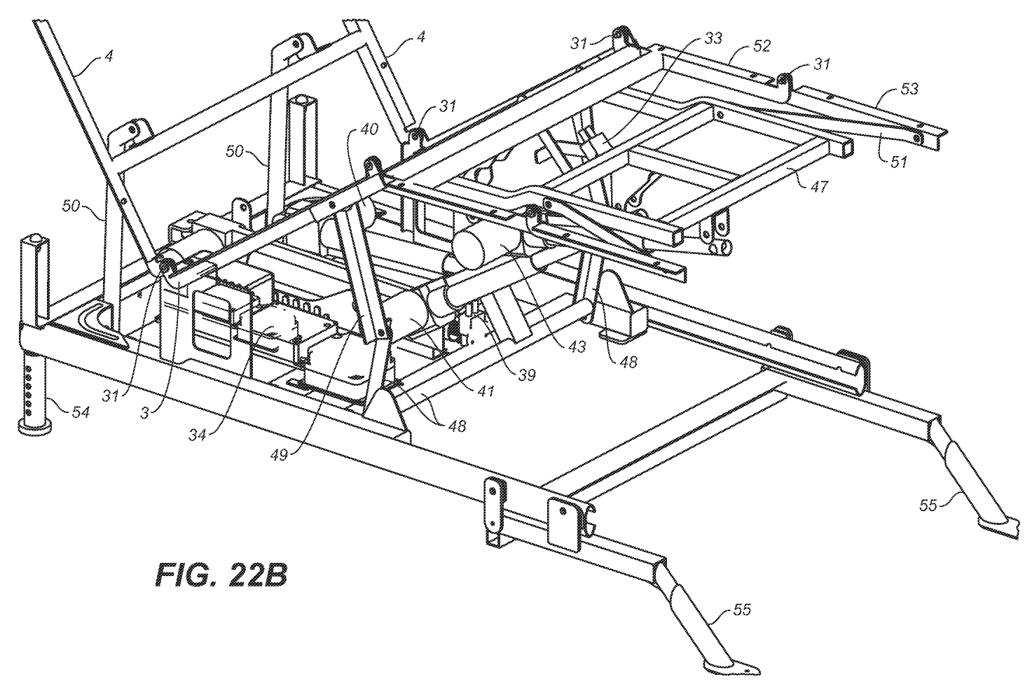

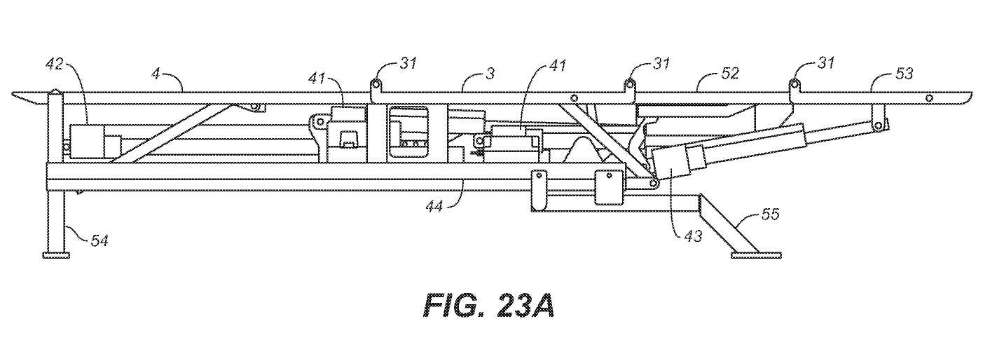

The carriage 45 is a rectangular tube weldment that supports all the bed sections and actuators, etc, and is rolled in track 44 by back section actuator 42 in the headward and footward direction. The carriage 45 has 6 track wheels 56 arranged with 3 per each of the two sides of the carriage side 58. The track wheels 56 are similar to that found in garage doors having a track wheel stem 57 with a shoulder, which is inserted through the carriage side tube 58. This allows stem to move axially through the two lateral holes in the carriage side tube to provide lateral tolerance for the track's 44 lack of lateral straightness, and allowing wheels to seat perfectly on the concave of the track 44 bottom as they roll headward and footward. The centrally located track wheel 56 has a vertical offset from the foot and head end track wheels 56 of the carriage side tube 58 being vertically higher to roll on the underside of the top of track 44 to prevent foot/head end carriage teetering in the track. FIG. 22A/B show the buttocks section 3 raised by the buttocks section actuator 40 rotating lower buttocks section lift arm 48, causing upper buttocks section lift arm 49 to pivotably raise buttocks section 3 about adjoining back section 4. This also lifts the adjoining thigh/calf sections and pivot swing arm 47 assembly pivotably in conjunction with the thigh/calf actuator 41 which supports the foot end of the thigh/calf section. Head adjustable height legs 54 and foot adjustable height legs 55 allow bed to be adjusted vertically to suit various bed frame furniture and mattress thicknesses. The spacing between height settings is greater on the foot leg relative to the head leg due to the angle of incline. Head end adjustable legs 54 also have an internal thread for fine adjustment for uneven floors. The controller 34 is mounted on the carriage apparatus 45 to reduce wire flexing.

FIG. 22A/B show the buttocks section 3 raised by the buttocks section actuator 40 rotating lower buttocks section lift arm 48, causing upper buttocks section lift arm 49 to pivotably raise buttocks section 3 about adjoining back section 4. This also lifts the adjoining thigh/calf sections and pivot swing arm 47 assembly pivotably in conjunction with the thigh/calf actuator 41 which supports the foot end of the thigh/calf section. Head adjustable height legs 54 and foot adjustable height legs 55 allow bed to be adjusted vertically to suit various bed frame furniture and mattress thicknesses. The spacing between height settings is greater on the foot leg relative to the head leg due to the angle of incline. Head end adjustable legs 54 also have an internal thread for fine adjustment for uneven floors. The controller 34 is mounted on the carriage apparatus 45 to reduce wire flexing.

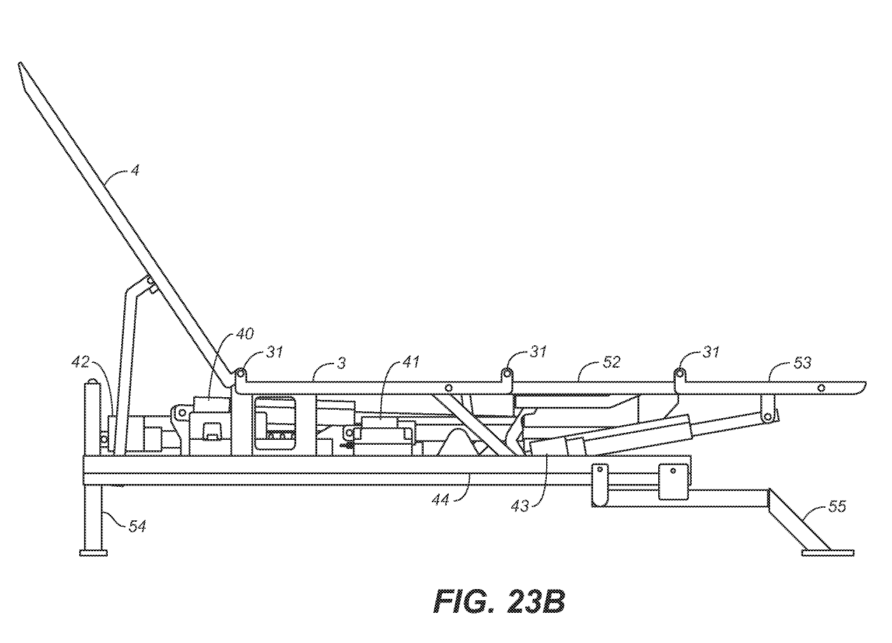

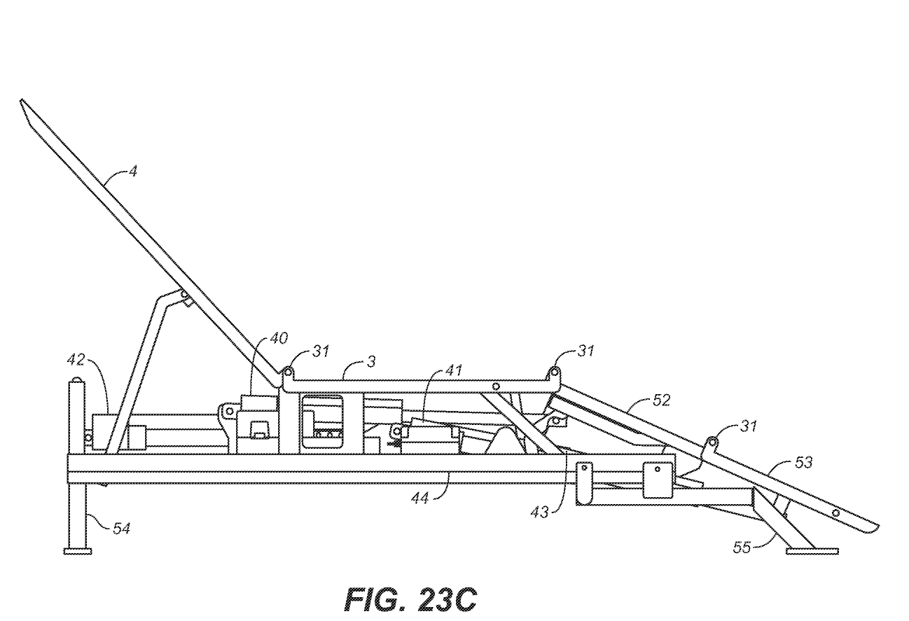

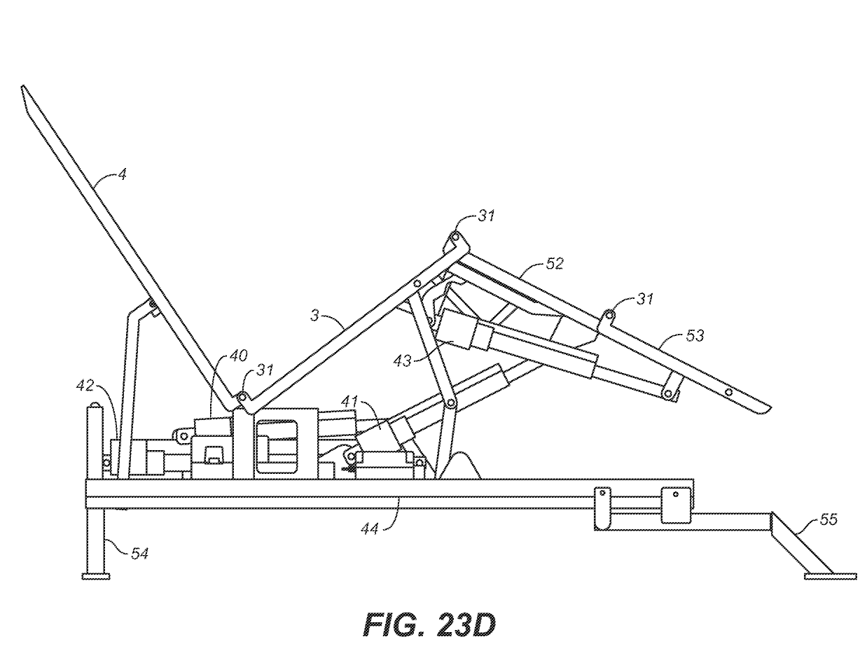

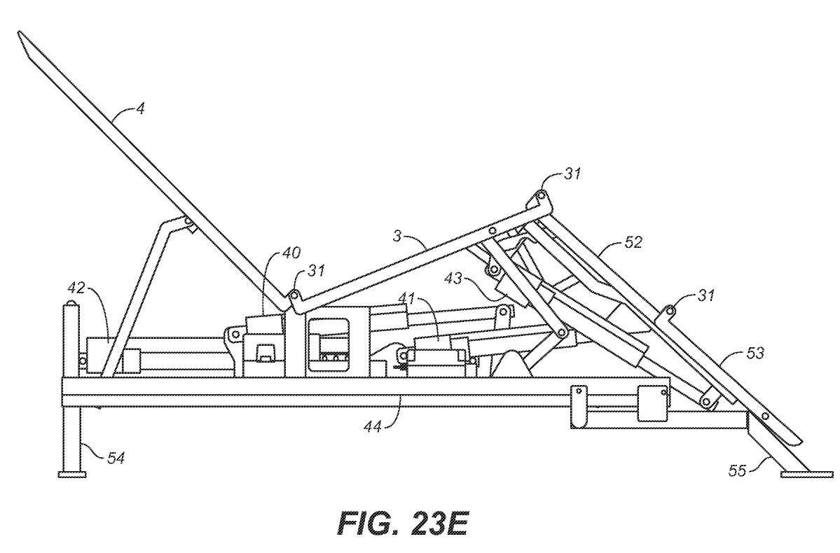

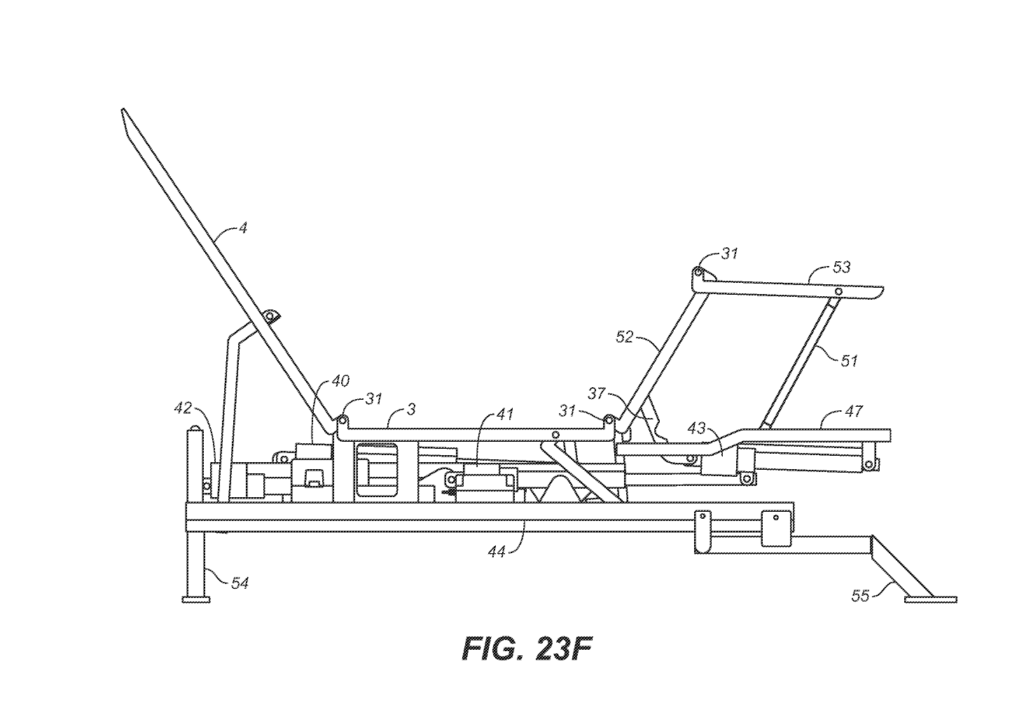

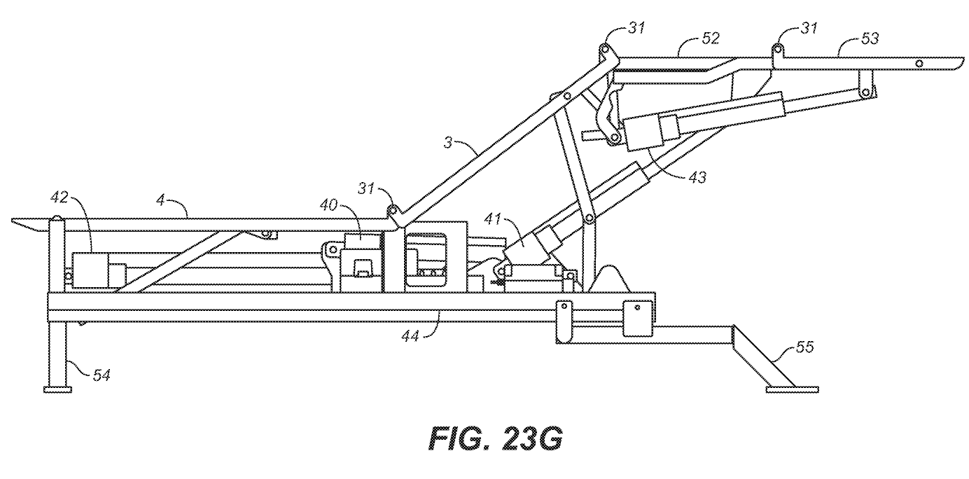

FIG. 23A—shows the bed horizontal for sleeping and shows a knee elevation actuator 43 fully extended and the thigh and calve section in a flat orientation, which are all connected and locked coplanar to the pivot swing arm 47, which is raised and lowered by the thigh/calves section actuator 41 below the horizontal position. A level arm 32 secured to the buttocks section 3 will ensure the thigh/calve sections 52, 53 will stop in the horizontal position, as shown here when it opens the level switch 33 which is secured to the pivot swing arm 47. Even after wear, minor damage or heavy weight on foot end, the level switch and arm will allow the thigh/calve actuator 41, which has extra extension capability, to bring the coplanar thigh/calve section level relative to the buttocks section 3 when it is horizontal. A 10 degree slope is also obtained by the excess extendibility of the thigh/calve actuator 41 for sleeping with the coplanar thigh/calve sections slightly elevated. The deck plywood 19 pieces (not shown) are secured to the angle iron frame 26 to make each of the sections. The hinge axis 31 protrude above the deck plywood 19 and will be comprised of a bolt or axis pin, bushings, and washers. When the carriage 45 rolls headward in track 44 as it is moved by back section actuator 42, this causes the back section lift arms 50 to raise the back section 4 pivotably about the buttocks section 3. The back section lift arms 50 and hinge axis 31 shown here are an alternate embodiment since they do not have their axis above the metal frame but rather below the deck plywood 19. Generally, the frame comprises the track, the cross member secured to track, the head end frame structure joining both tracks, the back section stop, and the frame enclosure. When rolled footward the back section limit switch 39 will stop the back section actuator 42 when either the back sections comes to rest on the back section stop 38 or if an obstruction blocks further downward travel, both instances causing the end of the actuator to travel along a double slotted clevis bracket along which the clevis pin travels horizontally, compressing a spring until the switch is opened. This acts as a safety switch as well as a limit switch rather than the prior art of a detaching lift arms from back section surface and subsequent free fall after the back section becomes unobstructed.

FIG. 23B—shows the bed horizontal except for the elevated back section and shows a knee elevation actuator 43 fully extended and the thigh and calve sections 52, 53 in flat orientation which are all connected and locked coplanar to the pivot swing arm 47, which is raised and lowered by the thigh/calves section actuator 41 below the horizontal position. A level arm 32 secured to the buttocks section 3 will ensure the thigh/calve sections 52, 53 will stop in the horizontal position, as shown here when it opens the level switch 33 which is secured to the pivot swing arm 47. Even after wear, minor damage or heavy weight on foot end, the level switch and arm will allow the thigh/calve actuator 41, which has extra extension capability, to bring the coplanar thigh/calve section level relative to the buttocks section 3 when it is horizontal. The deck plywood 19 pieces (not shown) are secured to the angle iron frame 26 to make each of the sections. The hinge axis 31 protrude above the deck plywood 19 and will be comprised of a bolt or axis pin, bushings, and washers. When the carriage 45 rolls headward in track 44 as it is moved by back section actuator 42, this causes back section lift arms 50 to raise back section 4 pivotably about the buttocks section 3. The back section lift arms 50 and hinge axis 31 show here are an alternate embodiment since they do not have their axis above the metal frame but rather below the deck plywood 19. When rolled footward the back section limit switch 39 will stop the back section actuator 42 when either the back sections comes to rest on the back section stop 38 or if an obstruction blocks further downward travel, both instances causing the end of the actuator to travel along a double slotted clevis bracket along which the clevis pin travels horizontally, compressing a spring until the switch is opened. This acts as a safety switch as well as a limit switch rather than the prior art of a detaching lift arms from back

FIG. 23C—shows the bed in a lawn chair position with the knee elevation actuator 43 fully extended and the thigh and calf sections 52, 53 in flat orientation, which are all connected and locked coplanar to the pivot swing arm 47, which is raised and lowered by the thigh/calves section actuator 41 below the horizontal position and is shown in it's lowered position with the buttocks section 3 horizontal. This position is ideal for a weak person getting out of bed as it allows the person's legs to swing to the side of the buttocks section 3 and then to brace one hand on the back section 4 for support. A beveled lowered foot edge removed from the foam perimeter will allow the upper foot edge to drop close to the floor to maximize the downward angle of the coplanar thigh/calf section. The collapsible bevel box spring structure 8 will also achieve this goal when foot edge causes it to rest on the floor while the thigh/calf sections 52, 53 continue to drop.

FIG. 23D shows the bed in a sit up position. The bed with the preferred embodiment of the back section lift arms 50 which have their hinge axis elevated above the angle iron frame 26 allows the back section 4 to be elevated to a higher angle than shown here. The buttocks section 3 is in an elevated position. The knee elevation actuator 43 is fully extended and the thigh and calf section are in flat orientation, which are all connected and locked coplanar to the pivot swing arm 47, which is raised and lowered by the thigh/calves section actuator 41 below the horizontal position, and is shown in it's lowered position with the buttocks section 3 tilted. This position gives support to the lower thigh section of the person to ergonomically relieve pressure on lower spine and buttocks for extended sitting time.

FIG. 23E shows the bed in a sit up position with the coplanar thigh/calf sections 52, 53 fully lowered. The bed with the preferred embodiment of the back section lift arms 50 which have their hinge axis elevated above the angle iron frame 26 allows the back section 4 to be elevated to a higher angle than shown here. The buttocks section 3 is in an elevated position. The knee elevation actuator 43 is fully extended and the thigh and calf sections 52, 53 are in flat orientation which are all connected and locked coplanar to the pivot swing arm 47, which is raised and lowered by the thigh/calves section actuator 41 below the horizontal position, and is shown in it's fully lowered position with the buttocks section 3 tilted. This position gives support to the lower thigh section of the person to ergonomically relieve pressure on lower spine and buttocks for extended sitting time. The buttocks section 3 can elevate farther in order to manipulate the mattress, which tends to reduce the angles on inclination of the bed due their smoothing or rounding of the mattress at the bends. The ability of the bed to obtain more extreme angles than would normally be comfortable for sitting is in order to compensate for various thicknesses and materials of mattresses which determine this rounding effect.

FIG. 23F—The back section lift arms 50 and hinge axis 31 shown here are the preferred embodiment since have their axis above the metal frame and protrude through an opening in the deck plywood 19 (which is not show). The additional height of the hinge axis 31 position relative to the mechanical structure for the lifting components decreases the lifting force required from the back section actuator 42 when the back section 4 is horizontal. The bed is shown with the knees elevated. The knee elevation actuator 43 retracts it's length to lift the calf section 52 and thigh section 53 from their locked coplanar position against the pivot swing arm 47 by rotating the knee lift arm 37 which in turn rotates the thigh section 53 with its adjoining calf section 52 as it's foot end is supported by the knee elevation arms 51 as they also rotate or swing. When the knee elevation actuator 43 fully extends it's length the calf section 52 and thigh section 53 return to their horizontal position and become locked in a coplanar position against the pivot swing arm 47 by the deck plywood pressing against the pivot swing arm 47. When knees are elevated above horizontal and the downward movement command of pressing the legs down button on the remote control, the knee elevation actuator 43 will stop when fully extended and thigh/calf sections 52, 53 coplanar and horizontal. By releasing and then pressing the same legs down button, the coplanar thigh/calves sections 52, 53 are lowered below horizontal by the thigh/calves actuator 41. The command for legs up is similar but reversed in direction in order that there is no guessing when the coplanar thigh/calves sections are horizontal for sleeping.

FIG. 23G—shows the bed with the buttocks section 3 fully tilted, coplanar thigh/calf sections 52, 53 horizontal and back section 4 down and horizontal. This unique position allows a person to lay on their stomach facing down and with their head at the foot end of the bed for extended periods of time to watch television, read and/or write, or engage in sexual intercourse while in this orientation. Generally people do not lay on their stomach for extended periods of sleep or other activities since the spine is uncomfortably straight or even arched backwards if the mattress is sagged. This position allows the back to be bent over to a set angle and have some of their body weight supported by their knees and mid section thus relieving and stretching the lower back area. During sexual intercourse where both people are facing downward, the upper persons body weight does not have to bear on the lower person, but is supported partially by their knees.

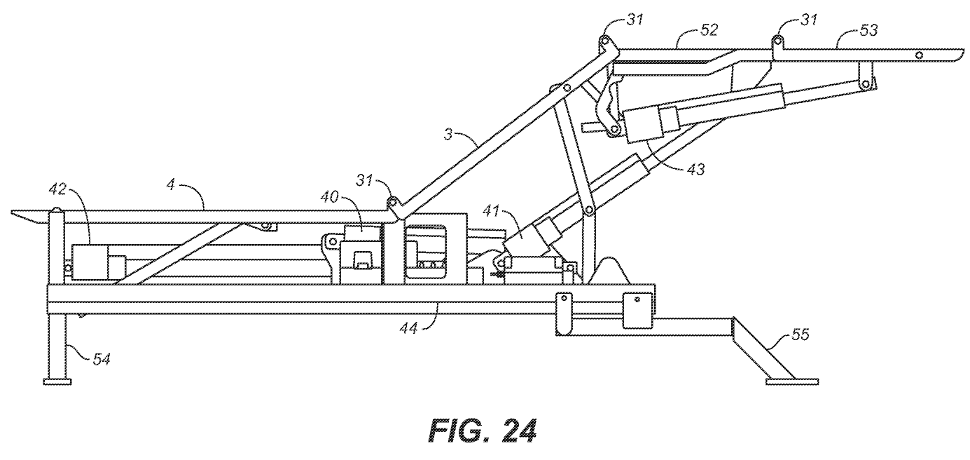

FIG. 24—shows the bed with the buttocks section 3 fully tilted, coplanar thigh/calves section horizontal and back section 4 down and horizontal. This unique position allows a person to lay on their stomach facing down and with their head at the foot end of the bed to watch television, read and/or write, or engage in sexual intercourse while in this orientation for extended periods of time. Generally people do not lay on their stomach for extended periods of sleep or other activities since the spine is uncomfortably straight or even arched backwards if the mattress is sagged. This position allows the back to be bent over to a set angle and have some of their body weight supported by their knees and mid section thus relieving and stretching the lower back area. During sexual intercourse where both people are facing downward, the upper persons body weight does not have to bear on the lower person, but is supported partially by their knees.

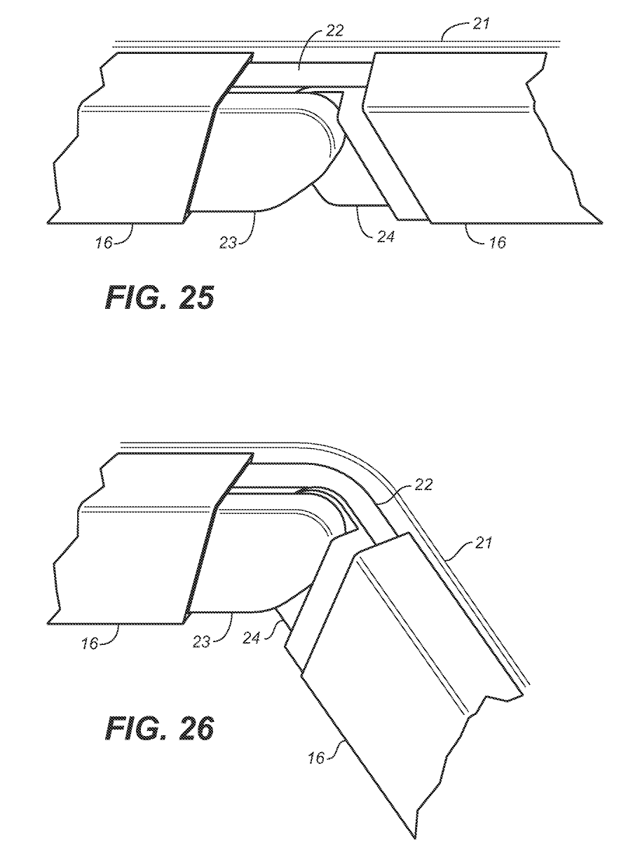

FIG. 25 shows the perimeter hinge point 23 and it's mating perimeter hinge point lowered section 24 and flex strip 22. The Euro perimeter is the edge around the plywood deck of the European style bed. This Euro perimeter is made of aluminum or plastic extrusion. The hinge points are secured by plugging into the ends of the extrusion 16. As an alternate embodiment, the Euro perimeter may also be made to include cornered radius, straight length and/or hinge points molded as a single part.

The perimeter hinge points 23 preferably have no fixed axis pins themselves, but an alternative embodiment with axis pins is also possible. The axis pin would require greater strength of the plastic hinge points in the event of sitting or impact of the plywood or perimeter extrusion, and the bed's frame hinge points provide a sufficient axis. The bed frame hinge points may actually be above the plywood deck, hence above the hinge point's body, making axis pins impossible. The perimeter hinge points eliminate pinch points at the perimeter. The flex strip 22 lies between perimeter hinge points mostly for appearance but also to prevent the end edges of the perimeter extrusion from wearing through the deck fabric 21. The flex strip 22 is stapled to the plywood deck on one end and the other end is free to slide between the perimeter extrusion 16 and deck fabric 21.

FIG. 26 shows the perimeter joint of FIG. 16 in it's lowered position.

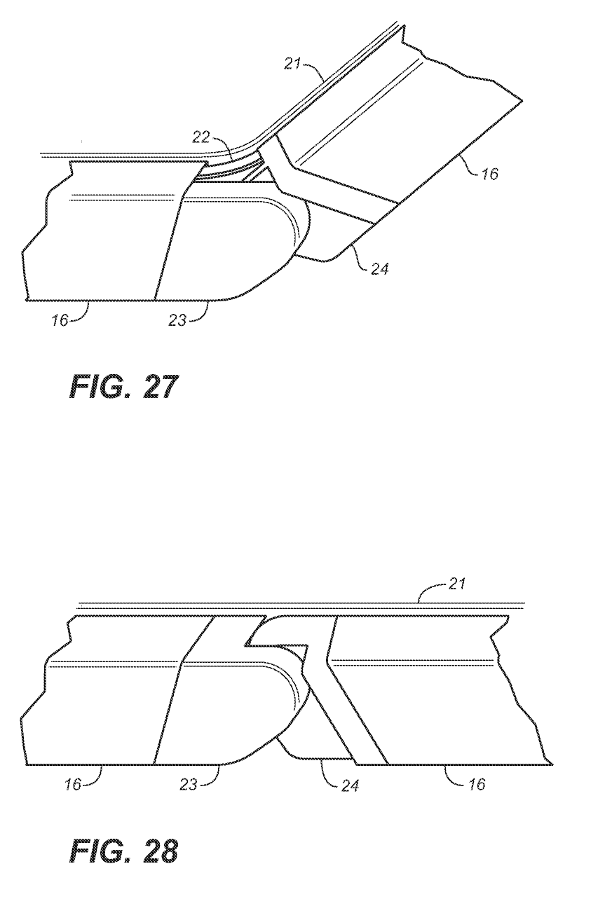

FIG. 27 shows the perimeter joint of FIG. 16 in its raised position.

FIG. 28 An alternative embodiment, to eliminate the flex strip, having the hinge points thicker (axially) to the same width as the extrusion and notches out the (preferably) plywood deck to prevent deck portion of hinge point from becoming too thin.

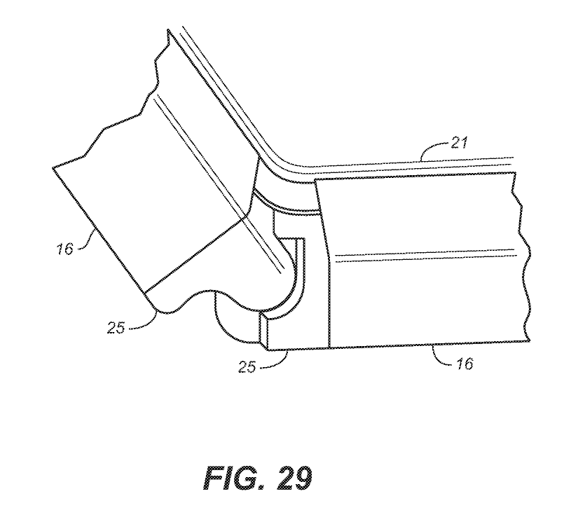

FIG. 29 shows perimeter hinge point raise only 25 alternative embodiment of the perimeter hinge points that are in locations where only movement in one direction occurs relative to the other section, such as at the butt and back section location. The basic hinge point shape can utilize an extrusion with and without an axis or axle pin at it's center of rotation.

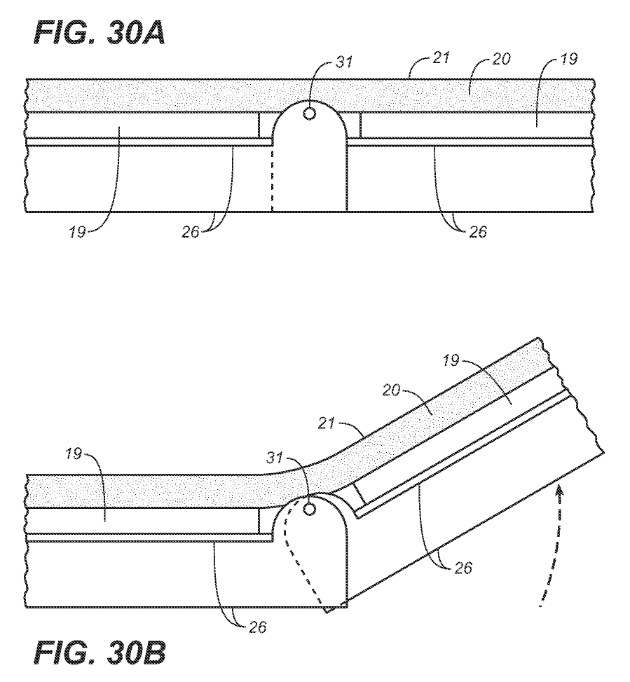

FIG. 30A shows deck fabric 21 over deck foam 20 on plywood deck 19 on angle iron frame 26. The deck section's hinge axis 31 are elevated above frame structure close to the top face of plywood deck 19. This reduces the gap between the plywood deck sections required for clearance. This embodiment allows greater movement of the sections as compared to common adjustable beds. This also reduces stretch and creasing of the deck cover material since there is less radial movement closer to the axis. Another purpose of the elevated axis 31 is to allow the axis to be in line with the axis of the perimeter hinge points to prevent their separation or longitudinal movement. The angle shown has the axis flap formed from the angle by cut and bend.

FIG. 30B shows FIG. 30A in an elevated position.

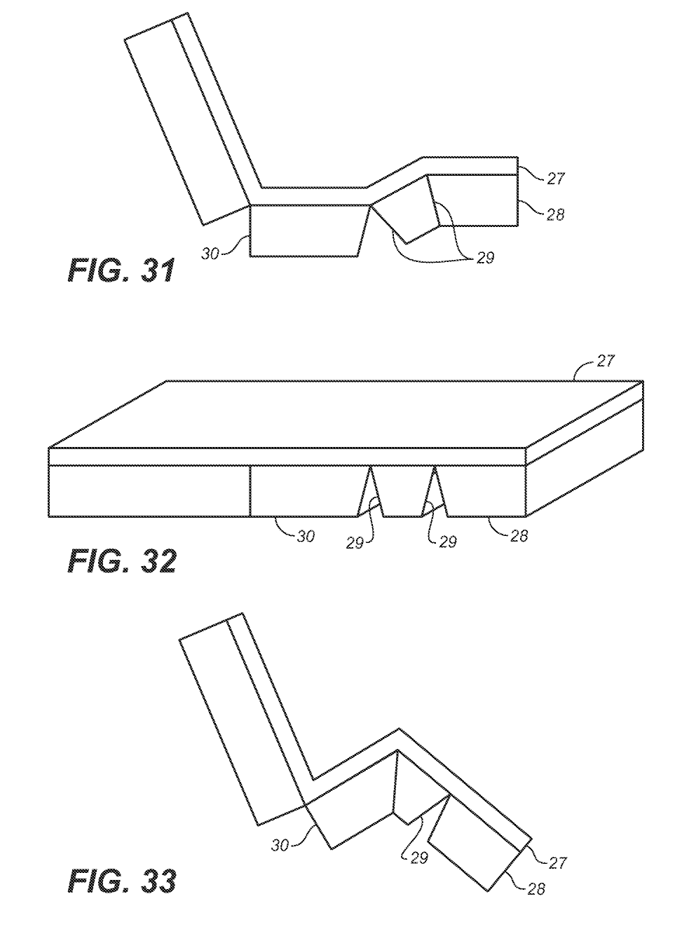

FIG. 31 shows the foam mattress angle cuts 29 and straight cut 30 to allow the relatively rigid polyurethane foam 28 to flex and to conform with the large angle movements of the butt and knee sections. The polyurethane foam 28 can be precut in smaller sections and then glued to the memory foam 27. As an alternative embodiment, it may also have angles cut so the ‘v’ cuts do not have to be completely through the polyurethane foam 28, leaving it as one piece, with say ½ inch depth left at the apex of the ‘V’. The foams may also be of various types of foams, such as latex instead of memory foam as an alternative embodiment. The foam may then be covered with a bedding material.

FIG. 32 shows the foam mattress of FIG. 22 in the horizontal position.

FIG. 33 shows the foam mattress of FIG. 22 in the sit up position.

FIGS. 31-33 support cuts in the polystyrene to allow for high angle bends.

### VII. OPERATION

Bolt legs 1 to track 44 and fold bolt cross member 12 to leg 1. Wireless remote control 36 is placed in accessible location and wired remote control 36 is placed in side pouch in base. Fold mattress braces 17 to it's unfolded position. Place mattress on base. Scroll to select the section of the bed to be moved. Press up or down buttons on remote to operate the selected section of the bed. When moving the buttocks section 3 down hold the remote control button down, the thigh/calf section will automatically be raised before the foot edge of the bed can touch the floor. Similarly holding the thigh/calf section button down for downward movement will automatically cause the buttocks section 3 to raise before the foot edge of the bed can touch the floor. When knees are elevated above horizontal and the downward movement command of pressing the legs down button on the remoter the knee elevation actuator 43 will stop when fully extended and thigh/calf section coplanar and horizontal. By releasing and then pressing the same legs down button, the coplanar thigh/calves section is lowered below horizontal by the thigh/calves actuator 41. The command for legs up is similar but reversed in direction in order that there is no guessing when the coplanar thigh/calves section is horizontal for sleeping.

I claim:

1. A multi-position wallhugger adjustable bed comprising:
a. a bed frame, having a head end, a foot end, and parallel sides defining a horizontally situated elongated track;
b. a plurality of legs supporting the bed frame;
c. a carriage apparatus capable of movement along the length of the elongated track,
d. a plurality of supporting elements positioned above and overlying the carriage apparatus, and moveably coupled thereto, said supporting elements comprising:
i. a back section having a head end and a foot end;
ii. a buttocks section having a head end and a foot end, and having the head end pivotably attached to the foot end of the back section;
iii. a thigh/calf section, having a head end and a foot end, and having the head end pivotally attached to the foot end of the buttocks section;
said supporting elements being pivotably connected to each other at abutting edges; and
e. a plurality of linear actuators mounted to the carriage apparatus and coupled to the supporting elements, comprising:
i. a first actuator capable of raising and lowering said buttocks section;
ii. a second actuator capable of raising and lowering said thigh/calf section,
iii. and a third actuator capable of moving the carriage apparatus horizontally along said track such that:
(1) as the carriage apparatus moves towards the head end of the frame, the back section is raised via a lever mechanism connecting the back section to the carriage apparatus;
(2) in combination with the movement of the back section via the third actuator, the head end of the back section remains in substantially the same vertical plane when the back section is raised or lowered; and
f. wherein the elongated track terminates at a point that allows the thigh/calf section to recline pivotally at an angle below the horizontal plane of the elongated track; and
g. a means to control the actuators.

2. The multi-position reclining bed of claim 1 wherein the plurality of legs supporting the bed frame comprise two arch shaped legs.

3. The multi-position reclining bed of claim 1 wherein the plurality of legs supporting the bed frame comprise a plurality of cantilever shaped legs.

4. The multi-position reclining bed of claim 3 wherein the plurality of cantilever shaped legs further comprises a cross member that attach to the cantilever shaped legs.

5. The multi-position reclining bed of claim 1 wherein the plurality of legs supporting the bed frame extend beyond the vertical plane of the head end of the back section of the carriage apparatus.

6. The multi-position reclining bed of claim 1, further comprising a rear cover attached to the head end of the back section.

7. The multi-position reclining bed of claim 1 wherein the thigh/calf section comprises two independent sections pivotally connected at abutting edges such that the thigh and calf sections are capable of independent movement relative to each other.

8. The multi-position reclining bed of claim 7, further comprising a forth actuator attached to the underside of the thigh section, wherein said forth actuator supports the calf section.

9. The multi-position reclining bed of claim 7 wherein the entire calf section extends beyond the foot end of the track.

10. The multi-position reclining bed of claim 7 wherein the thigh section is capable of extending beyond the foot end of the track.

11. The multi-position reclining bed of claim 1 wherein the means of controlling the actuators comprises an electronic remote control device.

12. The multi-position reclining bed of claim 11, wherein the electronic remote control device is encoded such that the calf section is restricted in the level it is allowed to recline.

13. The multi-position reclining bed of claim 12, wherein when the maximum reclining level of the calf section is attained, the control mechanism automatically raises the buttocks section without further lowering of the calf section.

14. The multi-position reclining bed of claim 1, wherein said supporting elements are pivotably connected to each other via a plurality of raised hinges located above the horizontal plane of the supporting elements.

15. The multi-position reclining bed of claim 7 wherein the thigh section extends beyond the foot end of the track when the supporting elements are in the horizontal position.

16. The multi-position reclining bed of claim 1, wherein said actuators comprise electric motors operably connected to elongated rods that are connected to said supporting elements.
